(19) United States
(12) Patent Application Publication
(10) Pub. No.: US 2005/0262768 A1
(43) Pub. Date: Dec. 1, 2005

(54) Standing flowerbed

(76) Inventor: Jozef Cybula, Gdynia (PL)

Correspondence Address: Horst M. Kasper, 13 Forest Drive, Warren, NJ, 07059, US

(21) Appl. No.: 10/771,617

(22) Filed: Feb. 4, 2004

(30) Foreign Application Priority Data
Aug. 4, 2003 (PL) WP-3847

(51) Int. Cl. A01G 9/02

(52) U.S. Cl. 47/83

(57) ABSTRACT

The characteristic features of the standing flowerbed according to the invention are: the flowerbed consists of the square, perpendicular base 1 with oval corners and the cylinder-like fixable ending 2 shaped in the symmetry axis. The vertical sleeve segments of the supporting column 3 are shapely joined with the ending and they are removable. On its side planes it has profiled perpendicular supports 4 with enforcing ribs for the flowerpots 5. The top of the supporting column is finished with the vertical sleeve segment 6, in the upper opening of which there is shapely placed a flowerpot 5, which is removable. In the inner space of the perpendicular square base 1, in the corners, there are cone-shaped nests 7 for flowerpots 5. Between them, in the symmetrical axis, there are nests 8 for the vertical sleeve segments 3 and 6 shaped as truncated cone at the connection side, slightly converging to the inside of the side planes.

The object of the invention is the standing flowerbed adjusted to spatial decoration of rooms with flowers in flowerpots.

The specification of the application pattern No. W.98715 presents the standing flowerbed, the base of which consists of three vertical rods. There are rings connecting the rods in such a way, that the planes connecting the points of contact between the rods with rings and the axles of the rings are inclinated at the angle of 120°. One of the rods above the upper ring radially encompasses the hemispherical bowl, whereas below the lower ring they are radially directed towards the ground, creating the legs of the flowerbed.

Another solution is known due to the application pattern No. W. 103785. The application describes the frame of the flower container consisting of the bowl formed by means of three rods, one of which, ring-shaped, is connected with two hemisphere-shaped rods crossing each other in the planes perpendicular to the rod plane. The bowl is supported by four vertical rods, the other ends of which are connected to the other rods, which—being turned over in relation to the two rods—create the legs of the frame construction.

The specification included in the application of the invention No. P.343297 presents the technical solution of for the flowerpots base. It consists of a ring and two or even eight supports permanently joined with the ring. Under the ring, the supports are bended to the outside, whereas the elements above the ring are flexible to be shaped by the user according to the needs and the shape placed in the saucer. In other variations the ends of the supports under the ring are clipped with another ring, or—in case of only two supports—their parts under the ring are bended to the outside and—in their bend planes—they constitute an acute angle.

The essence of the invention is the construction of the standing flowerbed including the square base with oval corners. Another element is a fixable ending connected with shapely and removable vertical segments of the supporting column. The side planes of the segments have flowerpot sleeve-like supports profiled with the enforcing ribs. The top ending of the supporting column is a vertical sleeve segment. The shapely and removable flowerpots are placed in the top opening of the sleeve. In the corners of the inner perpendicular space of the square base there are cone-shaped flowerpot nests. Between them, in the symmetrical axis, there are nests for the vertical sleeve segments shaped as truncated cone at the connection side, slightly converging to the inside of the side planes. The most attractive shape of the flowerpots is that of a truncated cone.

The object of the invention is shown in the example of the construction presented in the drawing.

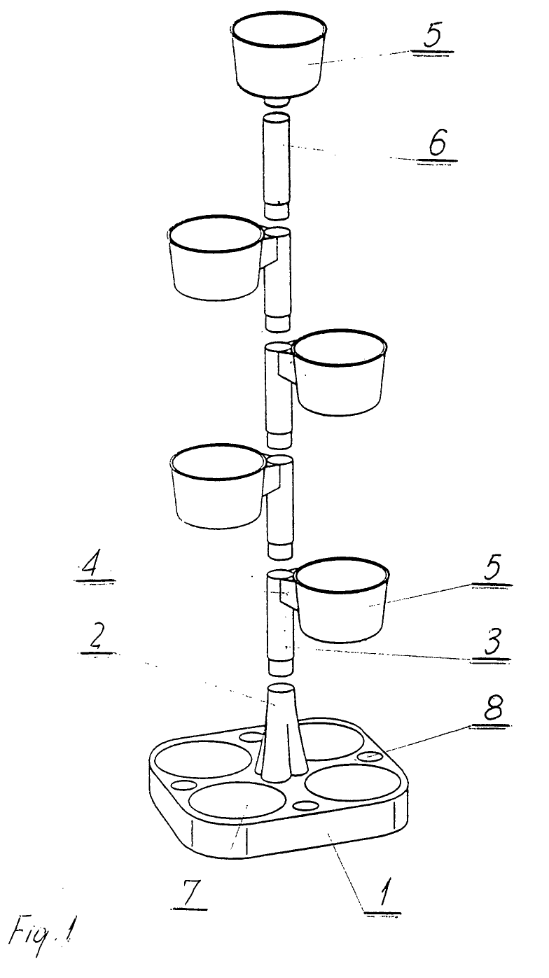

FIG. 1 presents the axonometric view of the flowerbed standing in the to-be-mounted position with the separated particular segments of the supporting column.

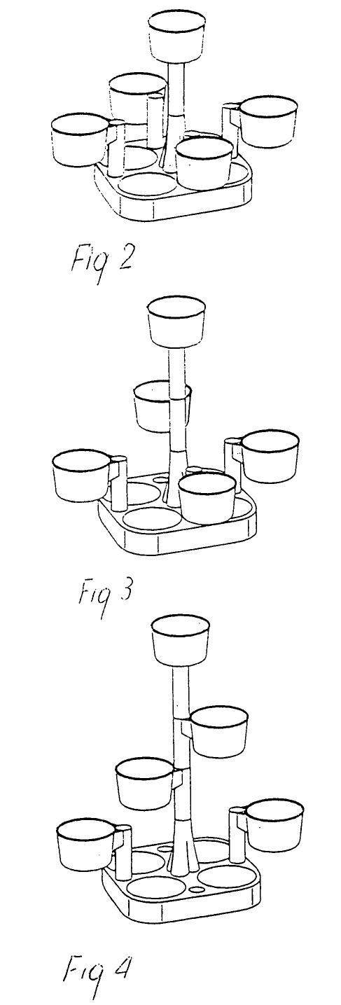

FIG. 2 presents the axonometric view of the flowerbed standing as a single segment construction with the base partly filled.

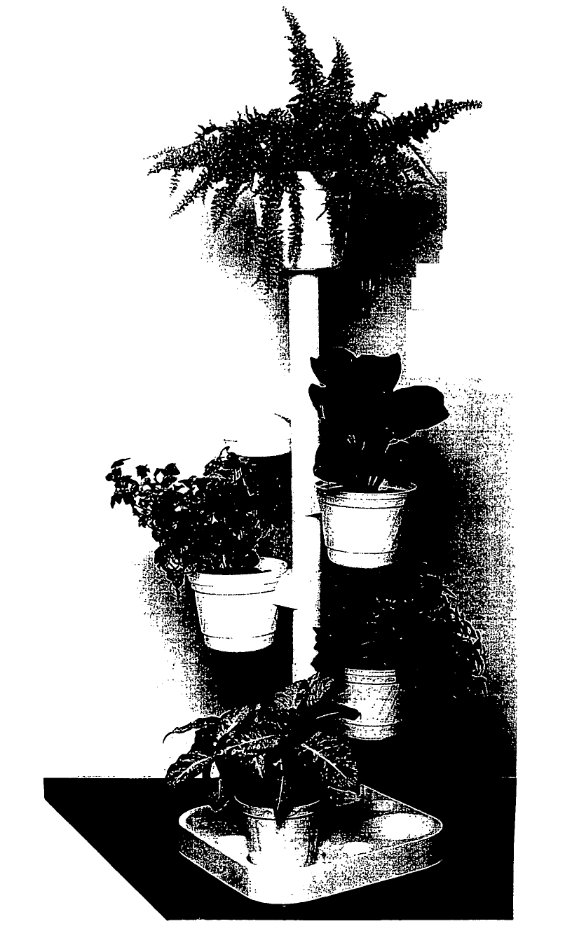

FIG. 3 presents the axonometric view of the flowerbed standing as a double segment construction with the base partly filled.

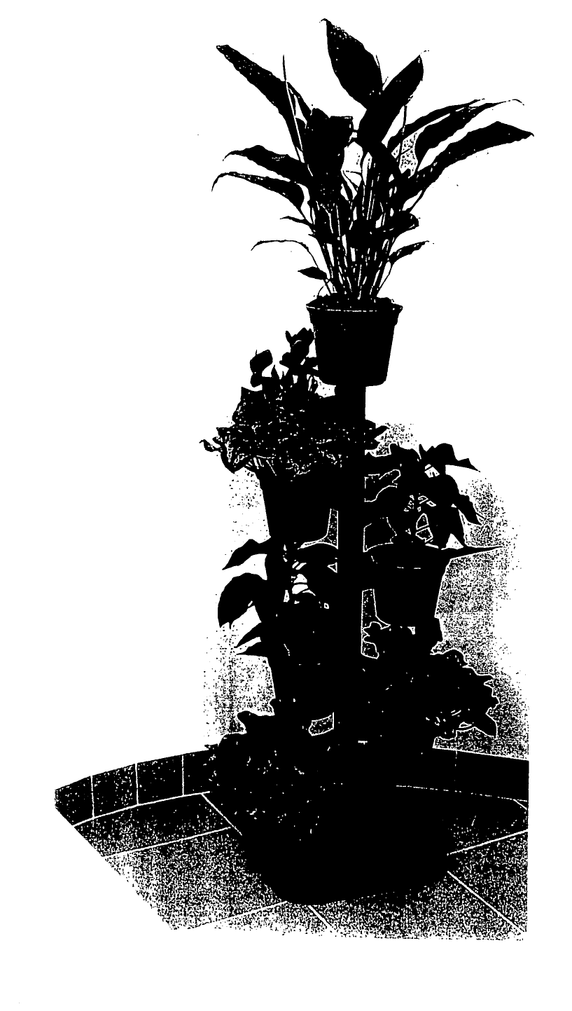

FIG. 4 presents the axonometric view of the flowerbed standing as a triple segment construction with the base partly filled.

The standing flowerbed—according to the invention—includes the base and the shapely and removable supporting segmented column. The particular segments have a profiled flowerpot on a support, and they enable the creation of free combinations of the flowerbed form. This concerns both the number of vertical segments and the number of the flowerpot nests. As well the shape and form of the flowerpot placement around the supporting column, the variations of the composition may be expanded by additional flowerpots placed in the cone-shaped nests at the base, and also vertical sleeve segments with flowerpots.

According to the invention, simple, light and compound construction, easy assembly and disassembly in case of need to change the configuration characterize the standing flowerbed. The segment construction and assembly advantages are very convenient in terms of transportation I storage.

Another important value of the flowerbed—according to the invention—is the easy access to flowers in case of watering or exchanging them. The large surface of the base secures the stability on the ground. The multiple available colours of the flowerbed surface make it possible to create an esthetic composition with the surrounding space of the location of the flowerbed. Still another important advantage of the flowerbed is the possibility to assembly it in various series of dimension types. The decorative and useful virtues of the invented flowerbed offer wide spectrum of possibilities to use it at home as well as at offices, conference halls and places of sophisticated interior design.

According to the invention, the standing flowerbed is made of plastic and the construction is thin-wall type. The flowerbed consists of the square, perpendicular base 1 with oval corners and the cylinder-like fixable ending 2 shaped in the symmetry axis. The vertical sleeve segments of the supporting column 3 are shapely joined with the ending and they are removable. On its side planes it has profiled perpendicular supports 4 with enforcing ribs for the flowerpots 5. The top of the supporting column is finished with the vertical sleeve segment 6, in the upper opening of which there is shapely placed a flowerpot 5, which is removable. In the inner space of the perpendicular square base 1, in the corners, there are cone-shaped nests 7 for flowerpots 5. Between them, in the symmetrical axis, there are nests 8 for the vertical sleeve segments 3 and 6 shaped as truncated cone at the connection side, slightly converging to the inside of the side planes. The above features enable easy and firm assembly and disassembly.

1. The standing flowerbed is made of plastic and its construction is thin-wall type. The characteristic features are: the flowerbed consists of the square, perpendicular base 1 with oval corners and the cylinder-like fixable ending 2 shaped in the symmetry axis. The vertical sleeve segments of the supporting column 3 are shapely joined with the ending and they are removable. On its side planes it has profiled perpendicular supports 4 with enforcing ribs for the flowerpots 5. The top of the supporting column is finished with the vertical sleeve segment 6, in the upper opening of which there is shapely placed a flowerpot 5, which is removable. In the inner space of the perpendicular square base 1 in the corners, there are cone-shaped nests 7 for flowerpots 5. Between them, in the symmetrical axis, there are nests 8 for the vertical sleeve segments 3 and 6 shaped as truncated cone at the connection side, slightly converging to the inside of the side planes.

2. The flowerbed specified in reservation 1 is characterized by the perpendicular base 1 which is square-shaped, whereas the most attractive shape of the flowerpots 5 is that of a truncated cones.
